(19) United States
(12) Patent Application Publication
(10) Pub. No.: US 2003/0236833 A1
(43) Pub. Date: Dec. 25, 2003

(54) Conferencing architecture, logic control module and conferencing module therefor

(76) Inventors: Roch Glitho, Montreal (CA); Kindy Sylla, Montreal (CA); Andre Poulin, Laval (CA); Emery Gbodossou, Montreal (CA)

Correspondence Address: SANDRA BEAUCHESNE, Ericsson Canada Inc., Patent Department (LMC/UP), 8400 Decarie Blvd., Town Mount Royal, QC, H4P 2N2, CA

(21) Appl. No.: 10/176,059

(22) Filed: Jun. 21, 2002

(51) Int. Cl. G06F 15/16

(52) U.S. Cl. 709/204

(57) ABSTRACT

The present invention relates to a conferencing architecture, and also to a logic control module and a conferencing module. The conferencing architecture, logic control module and conferencing module grant some of a group of terminal users communication rights to communicate together. The conferencing architecture includes both the logic control module and the conferencing module. The logic control module is in communication with the group of terminal users, and maintains a list of at least one predetermined criterion and associated communication rights. The logic control module monitors status of the terminal users and, upon a change of status of at least one of the terminal users, if the change of status corresponds to at least one of the predetermined criterion, generates a message for modifying the communication rights accordingly. The conferencing module receives the message and changes the communication rights amongst the terminal users in accordance with the message. The conferencing module generates an information message to the terminal users impacted by the change of status, for informing them of the changed communication rights.

### BACKGROUND OF THE INVENTION

1. FIELD OF THE INVENTION

The present invention relates generally to telecommunications, and in particular to a specialised conferencing architecture.

2. DESCRIPTION OF THE RELATED ART

Teleconferencing, such as multi-party calls and videoconferences, has been available for a relatively long time.

The usual way of setting up the necessary connections is to call the other participants after which the participants communicate until they hang up.

Another way is provided by the so-called party lines. Subscribers wishing to talk to other people call a specific number and are then connected to a number of other subscribers having dialled the same number. A difference between this and the previous way is that the identities and phone numbers of the other participants is not necessarily known at the beginning of the call.

Internet chat rooms and the like give yet another way. In brief, a subscriber logs on to a architecture on which can be found a number of different chat rooms. When the subscriber logs on to a chat room, he can communicate with one or more of the other subscribers in the same chat room.

From a certain point of view, there are limitations with the prior art solutions. As an example, it would be interesting to have a conditional conferencing feature, i.e. a conferencing which would allow to communicate with only some of the other participants, based on very specific considerations. This is not provided by the prior art solutions.

It can be appreciated that it would be advantageous to have solution for multiparty conferencing that overcomes disadvantages of the prior art. This invention provides such a solution.

### SUMMARY OF THE INVENTION

In one aspect, the present invention is a conferencing architecture for granting some of a group of terminal users communication rights to communicate together. The architecture comprises:

a logic control module in communication with the group of terminal users, the logic control module maintaining a list of at least one predetermined criterion and associated communication rights, the logic control module monitoring status of the terminal users and, upon a change of status of at least one of the terminal users, the change of status corresponding to at least one of the predetermined criterion, the logic control module generates a message for modifying the communication rights accordingly; and

a conferencing module for receiving the message and for changing the communication rights amongst the terminal users in accordance with the message, the conferencing module generating an information message to the terminal users impacted by the change of status, the information message informing the impacted terminal users of the changing communication rights.

It is also an object of the present invention to provide a logic control module for granting some of a group of terminal users communication rights to communicate together. The logic control module comprises:

a communication module for communicating with the group of terminal users;

a list of at least one predetermined criterion and associated communication rights; and

a monitoring module for monitoring status of the terminal users and, upon a change of status of at least one of the terminal users, the change of status corresponding to at least one of the predetermined criterion, having a message generated by the communication module, the message including parameters for informing the terminal users impacted by the change of status of the changing communication rights.

It is a further object of the present invention to provide a conferencing module for coordinating communication rights amongst a group of terminal users. The conferencing module comprises:

a control part for communicating with a logic control module and for receiving therefrom a message for modifying the communication rights of some of the group of terminal users in response to a change of status of at least one of the terminal users, the change of status corresponding to at least one predetermined criterion;

a media part in communication with the control part and with the group of terminal users, the media part generating an information message to be communicated to the terminal users impacted by the change of status, the information message informing the impacted terminal users of the changing communication rights.

### BRIEF DESCRIPTION OF THE DRAWINGS

For a more detailed understanding of the invention, for further objects and advantages thereof, reference can now be made to the following description, taken in conjunction with the accompanying drawings, in which:

FIG. 1 is a block chart of a preferred embodiment of a conferencing architecture according to the invention; and

FIG. 2 is a block chart of an alternate embodiment of conferencing architecture also according to the invention.

### DETAILED DESCRIPTION OF THE PREFERRED EMBODIMENTS

The innovative teachings of the present invention will be described with particular reference to numerous exemplary embodiments. However, it should be understood that this class of embodiments provides only a few examples of the many advantageous uses of the innovative teachings of the invention. In general, statements made in the specification of the present application do not necessarily limit any of the various claimed aspects of the present invention. Moreover, some statements may apply to some inventive features but not to others. In the drawings, like or similar elements are designated with identical reference numerals throughout the several views, and the various elements depicted are not necessarily drawn to scale.

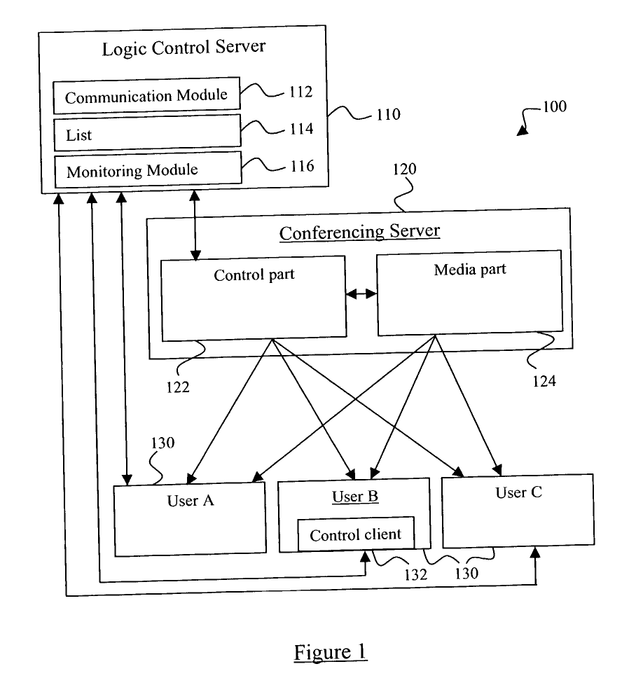

Reference is now made to FIG. 1, which depicts a block chart of a preferred embodiment of conferencing architecture in accordance with the invention. The conferencing architecture of the present invention aims at granting some of a group of terminal users communication rights to communicate together. For doing so, the conferencing architecture 100 comprises a logic control module 110 and a conferencing module 120. The logic control module 110 and the conferencing module 120, also respectively called hereinafter logic control server and conferencing server, may consist for example of dedicated servers in an Internet Protocol network. A number of terminals 130—having users A, B and C—are using the architecture 100. Only three terminals 130 are shown on FIG. 1, but it should be understood that the present invention is not limited to three, and does not require a minimum of three terminals 130. The terminals 130 can communicate using a same communication media, for example Wideband Code Division Multiple Access or Internet Protocol, or communicate using different communications medias independently.

To simplify understanding of the invention, an exemplary application of the architecture will be described when appropriate. This exemplary application relates to a cooperative multiplayer game in a virtual environment in which the terminal users, also referred to as players, have a task to perform. Also, in this exemplary application the players can only communicate when they are in the same virtual defined area in the game, or have other means of communication within the game, such as for example intercoms. Of course, any other application requiring similar granting of communication rights to some of a group or users would also encompassed by the present invention.

More particularly, the following description will, for understanding purposes, be directed towards a specific example where the cooperative multiplayer game consists of a virtual house, in which players have to visit virtual rooms, and can only communicate with the other players being currently in the same virtual room as they are.

The logic control server 110 is in communication with a control part 122 of the conferencing server 120. The control part 122 is in further communication with a media part 124 of the conferencing server. The terminals 130 are in communication with the logic control server 110, preferably via a control client 132 (shown only in terminal B), and both the control part 122 and the media part 124 of the conferencing server 120.

The logic control server consists of a communication module 112, a list 114 and a monitoring module 116. The communication module 112 communicates with the group of terminal users 130 through the conferencing server 120. The list 114 includes at least one predetermined criterion and its associated communication rights. For example, in the case of the virtual house, the predetermined criterion can be all users in the same virtual room and the associated communication rights is that they can communicate together. So, as soon as a user enters a room, where other users are located, also referred as a change of status of one of the terminal users, the logic control server is informed of the incoming user in the room, and determines that it is a criterion of the list, and updates the communication rights of all the users in the room accordingly, by sending a message (not shown) through the conferencing server 120. The message includes parameters for informing the terminal users impacted by the change of status of the changing communication rights.

When the game is initiated the control part 122 sends one or more messages to invite users of terminals A, B and C to a conference and, normally, they reply accepting the invitation. Then, in the game, when the users move around and interact, messages containing events are sent from the terminals 130 to the logic control server 110 to relate their actions( or also called change of status), and from the logic control server 110 to the terminals 130 to update their views following those events, and so on. The events are application specific actions that occur when one of the users interacts with the application. In the present example, the events are game specific actions that occur when one of the players play the game. Examples of game specific actions are, without being limited thereto: changing room, changing position in the room, and selecting an object. Whenever two terminals 130, e.g. terminal A and terminal C, are in the same room, i.e. when they should be able to communicate, the logic control server 110 sends a message to the control part 122 informing it that communication should be enabled between terminal A and terminal C, upon which the media part 124 relays information between the terminals 130 A and C.

If all three terminals A-C are in a room together and the logic control server 110 determines that one of them has left the room, for example terminal A, it sends a message to inform the control part 122 that in turn instructs the media part 124 to exclude the terminal A from the conference between the other terminals.

If one of the terminal, let's say 130 B, intends to leave the game and informs the logic control server 110 of this, one or more messages may also be sent to the terminal 130 B instructing it to take appropriate action, such as for example release any resources related to the conference.

In the event that the terminal 130 C disconnects abruptly without informing the logic control server 110, it is preferable that it at least informs the control part 122 that then in turn informs the logic control server 110 and the media part 124 that the terminal 130C is no longer connected, whereupon the two latter take appropriate action(s). It is also possible for the media part 124 to have an inactivity timer for each terminal 130 and to inform the control part 122 when one of the terminals 130 has not sent any information to the media part 124 in a predetermined time period.

The protocols of the messages sent between the different nodes are preferably:

eXtensible Markup Language (XML) between the logic control server 110 and the terminals 130,

Session Initiation Protocol (SIP) between the control part 122 and the terminals 130,

Real Time Protocol (RTP) between the media part 124 and the terminals 130,

a Megaco (H.248) based Application Program Interface (API) between control part 122 and the media part 124,

Parlay/OSA between the logic control server 110 and the control part 122, although it is to be understood that other protocols may also be used. It is further to be understood that there may be adaptation layers so that e.g. the logic control server 110 sends a message to one of these layers that translates to Parlay/OSA for further transmission to the control part 122. This makes the architecture more generic and more flexible.

It should be noted that it is possible to have the control part 122 invite the users of the terminals 130, negotiate the connections, and inform the media part 124, every time the terminals 130 are to be able to communicate, and then releases the resources when the communication is no longer possible. This approach, however, increases the signalling between the nodes.

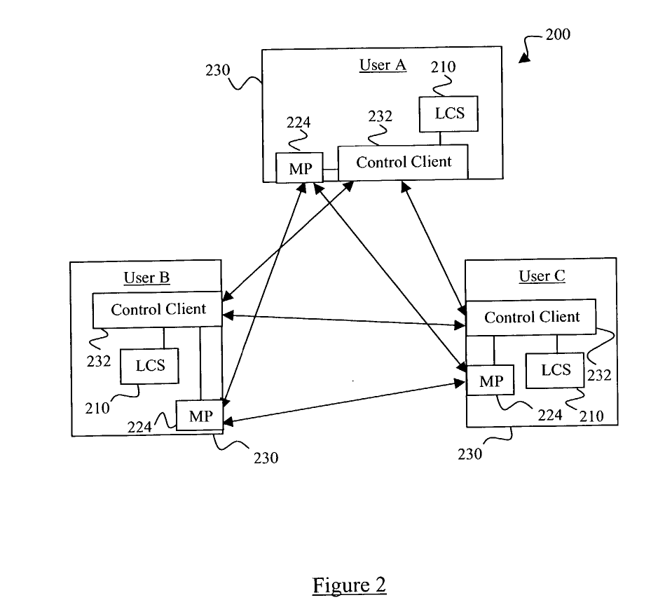

FIG. 2 shows a block chart of an alternate embodiment of conferencing architecture according to the invention. While the architecture in FIG. 1 was more centralised, the architecture in this figure is more distributed.

A conferencing architecture 200 is distributed on a number of terminals 230, client A-C. As in FIG. 1, the clients 230 have a control client server 232. The control client modules 232 are connected to each other externally, and each control client is connected to a media part 224 and a logic control server 210. The media parts 224, too, are connected to each other. In this embodiment too, the terminals 230 are preferably invited to a conference as the game is initiated or as a new player enters the game.

From the figure and the description, it can be seen that the architecture 200 of FIG. 2 provides much the same functionality as the architecture 100 of FIG. 1. The logic control servers 210 exchange information via the control clients 232 and determine when terminals 230 are in the same virtual room in the game and instruct the relevant media parts 224 to relay information between the concerned terminals 230. However, the major difference resides in the fact that the Logic Control Servers 210 and the Media Parts 224 are now distributed in the terminals of the terminals 230, instead of being centralized as in the previously described embodiment.

Hybrids between the architectures in FIG. 1 and FIG. 2 are also possible. This means that it is possible to have one or more centralized server from the architecture 100 of FIG. 1 and the rest of the servers decentralized in any of the way described for the architecture 200 of FIG. 2.

It should be understood that ‘in communication with’ and the like does not necessarily mean constant communication. Rather it means that one server has the possibility to communicate with another server and send a message whenever appropriate.

Although several preferred embodiments of the present invention have been illustrated in the accompanying drawings and described in the foregoing detailed description, it will be understood that the invention is not limited to the embodiments disclosed, but is capable of numerous rearrangements, modifications and substitutions without departing from the spirit of the invention as set forth and defined by the following claims.

What is claimed is:

1. A conferencing architecture for granting some of a group of terminal users communication rights to communicate together, the architecture comprising:
a logic control module in communication with the group of terminal users, the logic control module maintaining a list of at least one predetermined criterion and associated communication rights, the logic control module monitoring status of the terminal users and, upon a change of status of at least one of the terminal users, the change of status corresponding to at least one of the predetermined criterion, the logic control module generates a message for modifying the communication rights accordingly; and
a conferencing module for receiving the message and for changing the communication rights amongst the terminal users in accordance with the message, the conferencing module generating an information message to the terminal users impacted by the change of status, the information message informing the impacted terminal users of the changing communication rights.

2. The conferencing architecture of claim 1, wherein the conferencing module is composed of a control part and a media part.

3. The conferencing architecture of claim 1, wherein the logic control module communicates with the group of terminal users using different communication medias.

4. The conferencing architecture of claim 1, wherein the status relates to a position of the user of the terminal in a virtual game.

5. The conferencing architecture of claim 3, wherein the virtual game includes rooms in a virtual house, and the change of status is caused by any of the following events: changing room, changing position in the room, or selecting an object

6. The conferencing architecture of claim 4, wherein the predetermined criterion consists of one or a combination of: which room the terminal user is virtually in, which team the terminal user is virtually part of, which ally the terminal user virtually has.

7. The conferencing architecture of claim 2, wherein the logic control module and the control part communicate using Parlay/OSA protocol.

8. The conferencing architecture of claim 2, wherein the control part and the media part communicate using a Megaco (H.248) based Application Program Interface (API) protocol.

9. The conferencing architecture of claim 1, wherein the logic control module and the terminals communicate using an extensible Markup Language (XML) protocol.

10. The conferencing architecture of claim 2, wherein the media part and the terminals communicate using a Real Time Protocol (RTP).

11. The conferencing architecture of claim 1, wherein the terminal may consist of any of:
cellular phone, wireless personal digital assistant, or personal computer.

12. The conferencing architecture of claim 1, wherein the logic control module and the conferencing module consist of decentralized functionalities embedded in each terminal.

13. A logic control module for granting some of a group of terminal users communication rights to communicate together, the logic control module comprising:
a communication module for communicating with the group of terminal users;
a list of at least one predetermined criterion and associated communication rights; and
a monitoring module for monitoring status of the terminal users and, upon a change of status of at least one of the terminal users, the change of status corresponding to at least one of the predetermined criterion, having a message generated by the communication module, the message including parameters for informing the terminal users impacted by the change of status of the changing communication rights.

14. The logic control module of claim 12, wherein the status relates to a position of the user of the terminal in a virtual game.

15. The logic control module of claim 13, wherein the virtual game includes rooms in a virtual house, and the change of status is caused by any of the following events:
changing room, changing position in the room, or selecting an object

16. The logic control module of claim 14, wherein the predetermined criterion consists of one or a combination of: which room the terminal user is virtually in, which team the terminal user is virtually part of, which ally the terminal user virtually has.

17. The logic control module of claim 12, wherein the communication module and the terminals communicate using an extensible Markup Language (XML) protocol.

18. The logic control module of claim 12, wherein the communication module and some of the terminals communicate using a first communication media and the communication module and others of the terminals communicate using a second communication media.

19. A conferencing module for coordinating communication rights amongst a group of terminal users, the conferencing module comprising:
a control part for communicating with a logic control module and for receiving therefrom a message for modifying the communication rights of some of the group of terminal users in response to a change of status of at least one of the terminal users, the change of status corresponding to at least one predetermined criterion; and
a media part in communication with the control part and with the group of terminal users, the media part generating an information message to be communicated to the terminal users impacted by the change of status, the information message informing the impacted terminal users of the changing communication rights.

20. The conferencing module of claim 17, wherein the status relates to a position of the user of the terminal in a virtual game.

21. The conferencing module of claim 18, wherein the virtual game includes rooms in a virtual house, and the change of status is caused by any of the following events: changing room, changing position in the room, or selecting an object

22. The conferencing module of claim 19, wherein the predetermined criterion consists of one or a combination of: which room the terminal user is virtually in, which team the terminal user is virtually part of, which ally the terminal user virtually has.

23. The conferencing module of claim 17, wherein the logic control module and the control part communicate using Parlay/OSA protocol.

24. The conferencing module of claim 17, wherein the control part and the media part communicate using a Megaco (H.248) based Application Program Interface (API) protocol.

25. The conferencing module of claim 17, wherein the media part and the terminals communicate using a Real Time Protocol (RTP).
